(19) United States
(12) Patent Application Publication
(10) Pub. No.: US 2012/0167578 A1
(43) Pub. Date: Jul. 5, 2012

(54) FLAME HOLDING INHIBITOR FOR A LEAN PRE-NOZZLE FUEL INJECTION DIFFUSER AND RELATED METHOD

(75) Inventors: Jonathan Dwight BERRY, Simpsonville, SC (US); Michael HUGHES, Greer, SC (US); Chunyang WU, Greer, SC (US)

(73) Assignee: GENERAL ELECTRIC COMPANY, Schenectady, NY (US)

(21) Appl. No.: 12/984,274

(22) Filed: Jan. 4, 2011

(51) Int. Cl. F02C 7/22; F23R 3/28; F23R 3/42

(52) U.S. Cl. 60/772; 60/722; 60/737

(57) ABSTRACT

A flame holding inhibitor includes a base portion and an upstanding support extending away from the base portion; at least one delta-wing-shaped flap on the upstanding support, each having a relatively pointed end and a relatively broad end.

### TECHNICAL FIELD

This invention relates to gas turbine combustors, and specifically, to a flame holding inhibitor for use with a lean pre-nozzle injector diffuser located upstream of the combustor fuel nozzles.

### BACKGROUND OF THE INVENTION

In certain land-based gas turbine multi-combustor configurations, the individual combustors are arranged in an annular array about the gas turbine casing, each combustor supplying combustion gases to the first stage of the turbine. Each combustor is supplied with air from a compressor in a manner such that the compressor air is reverse-flowed into an annular air passage located between radially inner and axially-aligned transition piece and combustion chamber liner on the one hand, and radially outer, axially-aligned flow sleeve on the other. The compressor air generally flows into the passage through impingement cooling holes provided in the flow sleeve, thus also providing cooling to the transition piece and combustor liner, before reversing flow at the inlet or head end of the combustor.

In one low NOx combustor configuration, five radially-outer nozzles surround a sixth center nozzle. In this arrangement, three pre-mix manifolds stage fuel to the six burners while a fourth pre-mix manifold supplies fuel to a plurality of fuel pegs arranged in the air passage supplying combustion air to the combustor, upstream of the head end of the combustor that supports the six nozzles. While there is no intentional combustion at the fuel pegs, flame holding in this lean pre-nozzle fuel injection peg diffuser remains a problem when the fuel pegs are in operation. Flame holding occurrence in the diffuser is mainly caused by a locally-rich fuel air mixture which is created by unsatisfactory mixing and local flow separation around the trailing edges of the airfoil shaped fuel pegs, especially under large angles of attack. It would therefore be desirable to eliminate the flow separation by introducing secondary flow into the fuel/air jet mixing zone to eliminate the wake region along the trailing edge of the fuel pegs and to boost local air/fuel mixing.

### BRIEF SUMMARY OF THE INVENTION

In accordance with a first exemplary but nonlimiting embodiment, the invention provides a flame holding inhibitor comprising a base portion and an upstanding support extending away from the base portion; and at least one delta-wing-shaped flap on the upstanding support having a relatively pointed end and a relatively broad end.

In another exemplary but nonlimiting aspect, the present invention provides turbine fuel system incorporating one or more combustors, each combustor comprising a combustor liner having a head end supporting a plurality of nozzles and an aft end adapted for connection to a transition piece which, in use, carries hot combustion gases in a first direction to a first turbine stage; sleeve surrounding the combustor liner defining an annular flow path for compressor air that, in use, flows along the annular flow path in a second, opposite direction and then reverses to the first direction at the head end and flows into the combustor liner; a plurality of fuel pegs located in the annular flow path radially between the combustor liner and the flow sleeve, adjacent and upstream of the head end; and a plurality of flame holding inhibitors located upstream and in proximity to the fuel pegs.

In still another exemplary but nonlimiting aspect, the present invention provides a method for a method of enhancing flame holding margin and fuel/air premixing in a combustor that includes plural, radially-oriented fuel pegs in an air passage supplying combustion air to the combustor, where the plural, radially-oriented fuel pegs are located upstream of fuel nozzles supported in an end cover of the combustor, the method comprising (a) providing a flame inhibitor adjacent and upstream of each of said plural, radially-oriented fuel pegs; (b) aligning the flame inhibitor relative to fuel delivery holes in each of said plural, radially-oriented fuel pegs, such that vortices are created in the combustion air sufficient to insure premixing of the fuel issued from the fuel delivery holes, and to prevent fuel from adhering to exterior surfaces of each of said plural, radially-oriented fuel pegs.

The invention will now be described in greater detail in connection with the drawings identified below.

### BRIEF DESCRIPTION OF THE DRAWINGS

FIG. 1 is a simplified cross-section through a known gas turbine combustor;

FIG. 2 is a simplified forward end view of the combustor arrangement of FIG. 1;

FIG. 3 is a partial perspective view of quaternary fuel pegs and flame holding inhibitors in accordance with an exemplary but non-limiting embodiment of the invention;

FIG. 4 is an enlarged perspective view of a flame holding inhibitor device taken from FIG. 3;

FIG. 5 is a simplified flow diagram of a fuel peg without an adjacent flame holding inhibitor; and

FIG. 6 is a simplified flow diagram similar to FIG. 5 but illustrating flow when a flame holding inhibitor is located upstream and adjacent the quaternary fuel peg.

### DETAILED DESCRIPTION OF THE INVENTION

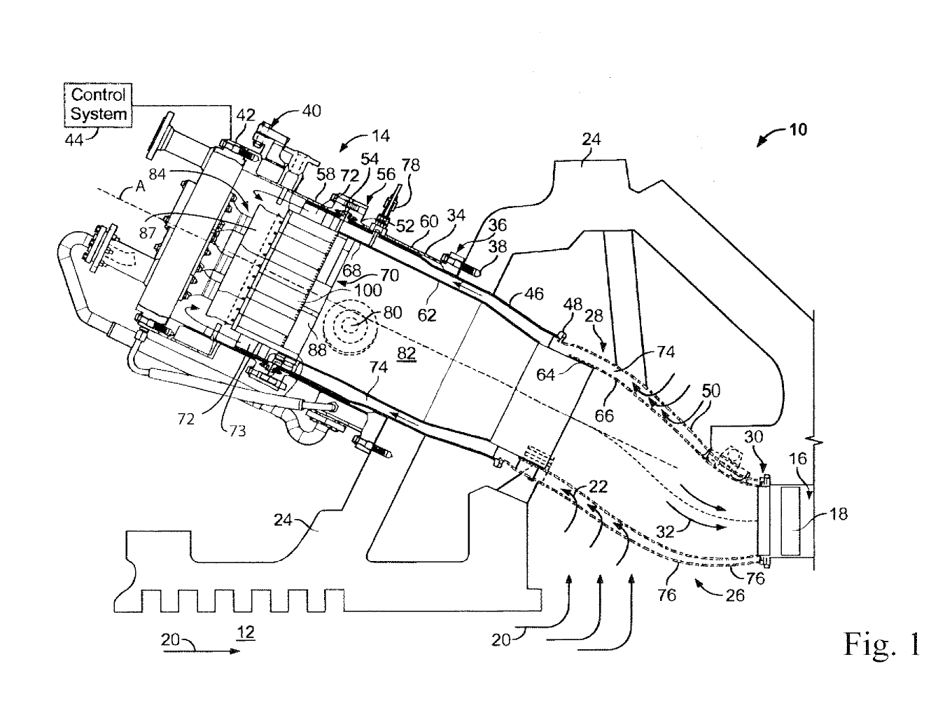

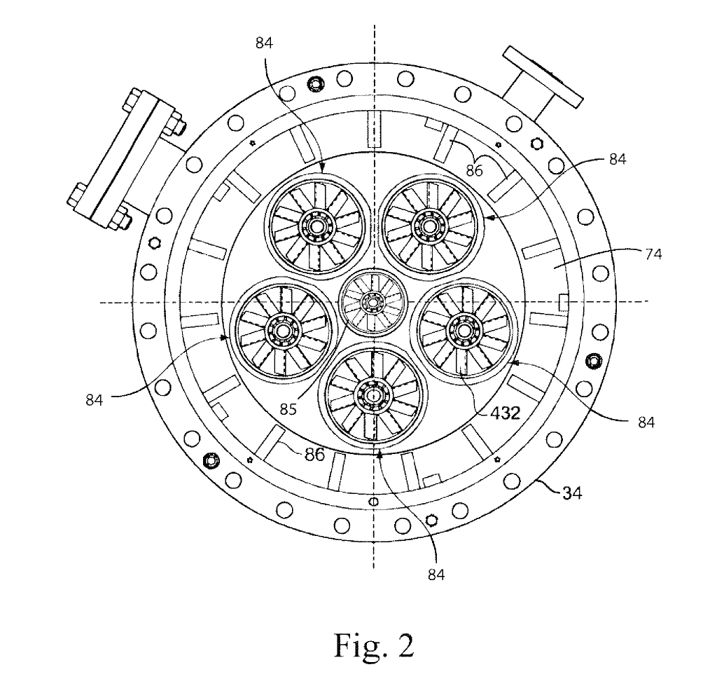

Referring initially to FIGS. 1 and 2, a gas turbine engine 10 includes a compressor 12, a combustor 14, and a turbine 16. Only a first stage nozzle 18 of turbine 16 is shown in FIG. 1. In the exemplary embodiment, turbine 16 is drivingly coupled to compressor 12 with rotors (not shown) that are connected by a single common shaft (not shown). Compressor 12 pressurizes inlet air 20 which is then channeled to an array of combustors 14 (one shown) where it cools the combustor 14 and provides air to the combustion process. More specifically, air 22 channeled to combustor flows in a direction generally opposite to the flow of air through engine 10. In the exemplary embodiment, gas turbine engine 10 includes a plurality of combustors 14 oriented circumferentially about engine casing 24. More specifically, in the exemplary embodiment, combustors 14 are, for example, but are not limited to a so-called “canannular” arrangement of combustors.

In the exemplary embodiment, engine 10 includes a double-walled transition duct 26. More specifically, in the exemplary embodiment, transition duct 26 extends between an outlet end 28 of each combustor 14 and the inlet end 30 of turbine 16 to channel combustion gases 32 into turbine 16. Further, in the exemplary embodiment, each combustor 14 includes a substantially cylindrical combustor casing 34. Combustor casing 34 is coupled at an open aft end 36 to engine casing 24. Combustor casing 34 may be coupled to engine casing 24 using, for example, but not limited to using, bolts 38, mechanical fasteners (not shown), welding, and/or any other suitable coupling means that enables engine 10 to function as described herein. In the exemplary embodiment, a forward end 40 of combustor casing 34 is coupled to an end cover assembly 42. End cover assembly 42 includes, for example, supply tubes, manifolds, valves for channeling gaseous fuel, liquid fuel, air and/or water to the combustor, and/or any other components that enable engine 10 to function as described herein. In the exemplary embodiment, the components within end cover assembly 42 are coupled to a control system 44 for controlling at least the air and fuel entering combustor 14. Control system 44 may be, for example, but is not limited to a computer system and/or any other system that enables combustor 14 to function as described herein.

In the exemplary embodiment, a substantially cylindrical flow sleeve 46 is coupled within combustor casing 34 such that the flow sleeve 46 is substantially concentrically aligned with casing 34. Flow sleeve 46 is coupled at an aft end 48 to an outer wall 50 of transition duct 26 and coupled at a forward end 52 to combustor casing 34. More specifically, in the exemplary embodiment, forward end 52 is coupled to combustor casing 34 by, for example, coupling a radial flange 54 of sleeve 46 to combustor casing 34 at a butt joint 56 such that a forward section 58 and an aft section 60 of casing 34 are coupled against each other. Alternatively, sleeve 46 may be coupled to casing 34 and/or transition duct 26 using any other suitable coupling assembly that enables engine 10 to function as described herein.

Flow sleeve 46, in the exemplary embodiment, includes a combustion liner 62 coupled therein. Combustion liner 62 is aligned substantially concentrically within flow sleeve 46 such that an aft end 64 is coupled to an inner wall 66 of transition duct 26, and such that a forward end 68 is coupled to a combustion liner cap assembly 70. Combustion liner cap assembly 70 is secured within combustor casing 34 by a plurality of struts 72 and an associated mounting assembly (not shown). In the exemplary embodiment, an air passage 74 is defined between liner 62 and flow sleeve 46, and between transition duct inner and outer walls 66 and 50 and between cap inner barrel 73 and the inner wall of forward casing 58. Transition duct outer wall 50 includes a plurality of apertures 76 formed therein that enable compressed air 20 from compressor 12 to enter air passage 74. In the exemplary embodiment, air 22 flows in a direction opposite to a direction of flow 20 from compressor 12 towards end cover assembly 42.

Further, in the exemplary embodiment, combustor 14 also includes a plurality of spark plugs 78 and a plurality of cross-fire tubes 80. Spark plugs 78 and cross-fire tubes extend through ports (not shown) in liner 62 that are defined downstream from combustion liner cap assembly 70 within a combustion zone 82. Spark plugs 78 and cross-fire tubes 80 ignite fuel and air within each combustor 14 to create combustion gases 32.

In the exemplary embodiment, a plurality of fuel nozzle assemblies are coupled to end cover assembly 42. More specifically, in the exemplary embodiment, combustor includes six nozzle assemblies, including five outer nozzle assemblies 84 arranged about a center nozzle assembly 85 the center of which lies on the longitudinal axis A of the combustor. Alternatively, combustor 14 may include more or less than five fuel nozzle assemblies 400. In the exemplary embodiment, outer fuel nozzle assemblies are arranged in a generally circular array about the center nozzle 85 and the centerline A of combustor 14, best seen in FIG. 2. Alternatively, fuel nozzle assemblies 400 may be arranged in a non-circular array.

Further, in the exemplary embodiment, combustor 14 includes a plurality of fuel pegs 86 that extend radially into the air passage 74 from combustor casing 34, and substantially circumscribe fuel nozzle assemblies 84. The fuel pegs 86 are thus located upstream of the head end of the combustor, and thus upstream of the location where the air reverses direction and flows into the nozzle air inlet ends 87.

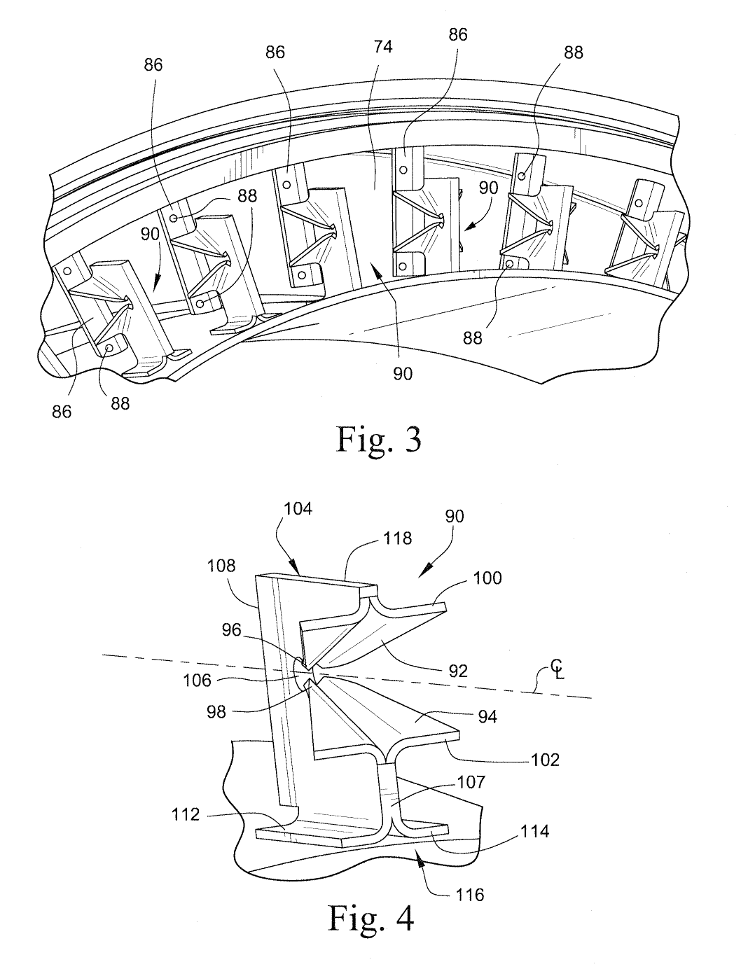

Referring now to FIG. 3, there are shown a plurality of the quaternary fuel pegs 86 extending radially into the air passage 74 at circumferentially spaced locations. There may be as many as 16 or more pegs, each of which is of substantially symmetrically, airfoil shaped, with the leading edge facing upstream, i.e., in a direction opposite the flow of air in the passage 74. Each fuel peg 86 may be formed with a pair of fuel delivery orifices 88 on each side of the peg. The orifices may be aligned radially, as shown in FIG. 3, such that fuel emitted from the orifices 88 flows into the passage 74 from each side of the peg, in directions transverse to the flow of air.

In the exemplary but nonlimiting embodiment, and with additional references to FIG. 4, a lean pre-nozzle fuel injection diffuser (also referred to as a flame holding inhibitor or vortex generator) 90 is located upstream (but proximate to) each of the fuel pegs 86. Since the flame holding inhibitors are substantially identical, only one need be described in detail. With particular reference to FIG. 4, the flame holding inhibitor 90 may be constructed from sheet metal and includes at least one and preferably two substantially identical, radially aligned triangle plates, or delta wings, 92, 94 that are angled toward each other such that the sharp leading ends 96, 98 nearly touch, while the blunt or wider trailing ends 100, 102, are radially spaced. The delta wings 92, 94 are cut (by laser cutting, for example) and bent from a single piece of plate stock 104 which forms an upstanding support for the delta wings. More specifically, a horizontal cut is made in the plate, extending from a hole 106 located between fore and aft edges 108, 110 of the plate that facilitates the cutting and bending process. Vertical (or radial) cuts along and within the thickness of the plate allow flaps of material to be the “peeled back” and bent in opposite directions to form the delta wings 92, 94. The radial distance between the delta wings at the trailing edge, is determined by the angle of divergence therebetween, is dependent on the location of the fuel delivery orifices 88 in the downstream adjacent fuel peg 86. An additional cut at the lower for radially inner) end of the plate allows the bending of two additional flaps 112, 114 to be bent in opposite directions to form a base 116 by which the flame holding inhibitor is attached to the combustor liner 62 or cap inner barrel 73 by, for example, welding or other suitable means. Note that the radially outer edges 118 of the flame holding inhibitors need not extend to the flow sleeve. More important is the location of the delta wings 92, 94 relative to the fuel delivery orifices 88 as explained further below.

In an alternative arrangement, the inhibitors 90 may be rotated 180° so as to face in an opposite direction relative to the orientation of FIG. 3. In other words, for this alternative arrangement, the pointed or sharp leading ends 96, 98 of the inhibitor 90 will face in the downstream direction. Further adjustment of the location of the fuel delivery orifices 88 may be required to optimize air/fuel mixing and to prevent fuel from stagnating in the center of the vortex created by the inhibitor.

it will be appreciated that the flame holding inhibitor 90 may also be formed in other ways and may include more than one component part. As noted above, for example, the inhibitor 90 may be formed with one, rather than a pair of delta wings.

Installed as shown in FIG. 3, the delta wings 92, 94 point in the upstream direction, (i.e., with the pointed or sharp leading ends 96, 98 facing upstream) and as noted above, the location of the leading ends 96, 98 of the delta wings 92, 94 can be adjusted relative to the location of the fuel delivery orifices 88 in the fuel pegs 86 to achieve optimum fuel/air mixing and minimization if not elimination of the flow separation zone adherent to the peg, as described further below.

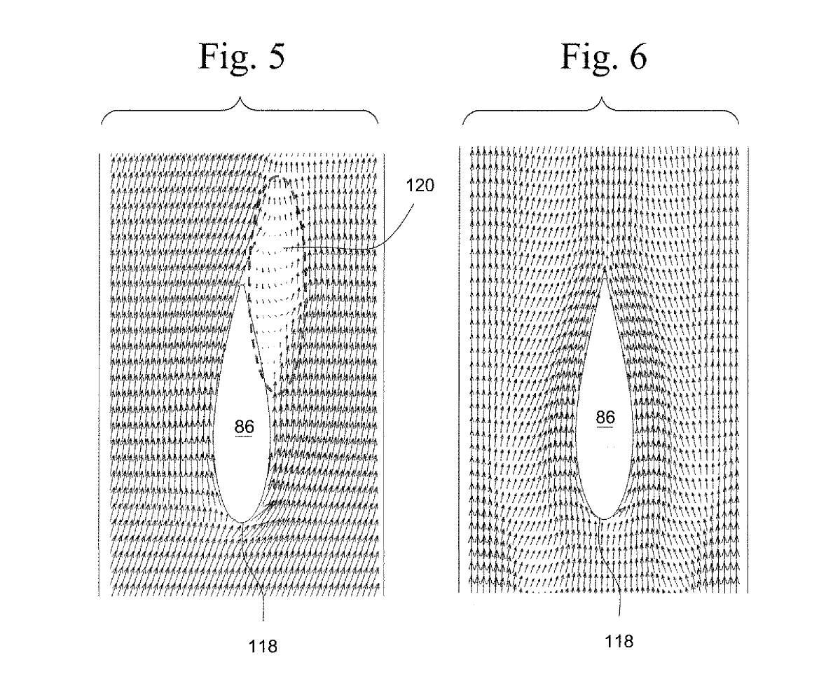

FIG. 5 is a schematic diagram of a fuel peg 86 and the flow of air in the passage 74 impinging on the leading edge 118 at an angle of attack of about 20°. With no flame inhibitor in place, the flow separates along the trailing edge portion of the peg, creating a flow separation zone in a wake region or “bubble” area 120 that distorts and traps the fuel mass fraction on the surface of the peg. Should an unintended flame event occur, the locally rich fuel/air mixture flame in the bubble area could be anchored or held on the peg. FIG. 6 is a similar view but shows the modification of the flow across the peg 86 when a flame holding inhibitor 90 is installed upstream of the peg 86. Now, the flow separation zone in the wake region or bubble area 120 is essentially eliminated by the secondary flows or vortices generated by the delta wings 92, 94 of the flame holding inhibitor 90. In addition, because the fuel entering the path 74 from the fuel delivery orifices 88 is aligned with the incoming flow generated by the delta wings 92, 94, the local fuel-rich stream is washed away with enhanced local fuel/air mixing.

As incoming air flows by the inhibitors, secondary flow (flows on the planes normal to the bulk flow direction) forms vortices, eliminates the wake regions and enhances local mixing.

It will be appreciated therefore that the benefits of flame holding inhibitor as described herein are twofold: 1. The flame holding margin of existing quaternary fuel pegs can be improved through the elimination of the near-peg flow separation zone; and 2. efficient fuel/air mixing is boosted, providing the potential for further reductions in NOx emissions by mixing a large fraction of total fuel with incoming air upstream of the combustor fuel nozzles.

It will also be appreciated that the flame holding inhibitor design could also be utilized elsewhere, for example, in the jet mixing zone of the combustor, and that the inhibitor may be of other shapes that perform in similar manner to achieve similar results.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A flame inhibitor comprising:
a base portion and an upstanding support extending away from said base portion; and
at least one delta-wing-shaped flap on said upstanding support having a relatively pointed end and a relatively blunt end.

2. The flame inhibitor of claim 1 wherein said at least one delta-wing shaped flap comprises a pair of substantially vertically-aligned delta wing-shaped flaps arranged such that said delta-wing-shaped flaps extend at an acute opposite angles relative to a horizontal center line between said delta-wing-shaped flaps.

3. The flame inhibitor of claim 2 wherein said pair of substantially vertically-aligned delta-wing-shaped flaps are located above said base portion and below an upper edge of said upstanding support.

4. The flame inhibitor of claim 2 wherein said pair of substantially vertically-aligned delta-wing-shaped flaps diverge in a direction from said relatively pointed ends to said relatively blunt ends.

5. The flame inhibitor of claim 2 wherein said upstanding support has forward and rearward edges, said relatively pointed ends located substantially mid-way between said forward and rearward edges.

6. The flame inhibitor of claim 5 wherein said relatively pointed ends extend from an aperture formed in said upstanding support.

7. The flame inhibitor of claim 6 wherein said delta-wing-shaped flaps extend at acute, opposite 30° angles relative to a horizontal center line passing through said aperture and between said delta-wing-shaped flaps, and substantially perpendicular to said upstanding support.

8. The flame inhibitor of claim 2 wherein said base portion, said upstanding support and said pair of substantially vertically-aligned delta-wing-shaped flaps are formed from a single piece of metal stock.

9. A turbine fuel system incorporating one or more combustors, each combustor comprising:
a combustor liner having a head end supporting a plurality of nozzles and an aft end adapted for connection to a transition piece which, in use, carries hot combustion gases in a first direction to a first turbine stage;
a sleeve surrounding said combustor liner defining an annular flow path for compressor air that, in use, flows along said annular flow path in a second, opposite direction and then reverses to said first direction at said head end and flows into said combustor liner;
a plurality of fuel injection pegs located in said annular flow path radially between said combustor liner and said flow sleeve, adjacent and upstream of said head end; and
a plurality of flame inhibitors located upstream and in proximity to said plurality of fuel injection pegs.

10. The turbine fuel system of claim 9 wherein said plurality of flame inhibitors are arranged in circumferentially-spaced relationship about said annular flow path, in substantial axial alignment with said plurality of fuel injection pegs.

11. The turbine fuel system of claim 9 wherein each flame inhibitor comprises a base portion and an upstanding support extending away from said base portion;
a pair of substantially vertically-aligned delta-wing-shaped flaps on said upstanding support, each having a relatively pointed end and a relatively blunt end and arranged such that said delta-wing-shaped flaps extend at acute opposite angles relative to each other.

12. The turbine fuel system of claim 9 wherein said pair of substantially vertically-aligned delta-wing-shaped flaps are located above said base portion and below an upper edge of said upstanding support.

13. The turbine fuel system of claim 9 wherein said pair of substantially vertically-aligned delta-wing-shaped flaps diverge in a downstream direction from said relatively pointed ends to said relatively blunt ends, said relatively blunt ends located, respectively, in proximity to radially inner and outer fuel orifices in said plurality of fuel injection pegs.

14. The turbine fuel system of claim 13 wherein said upstanding support has forward and rearward edges, said relatively pointed ends located substantially mid-way between said forward and rearward edges.

15. The turbine fuel system of claim 14 wherein said relatively pointed ends extend from an aperture formed in said upstanding support.

16. The turbine fuel system of claim 13 wherein said delta-wing-shaped flaps extend at acute, opposite 30° angles relative to a horizontal line passing through said aperture and substantially perpendicular to said upstanding support.

17. The turbine fuel system of claim 11 wherein said base portion, said upstanding support and said pair of substantially vertically-aligned delta-wing-shaped flaps are formed from a single piece of metal stock.

18. A method of enhancing flame holding margin and fuel/air premixing in a combustor that includes plural, radially-oriented fuel pegs in an air passage supplying combustion air to the combustor, where said plural, radially-oriented fuel pegs are located upstream of fuel nozzles supported in an end cover of the combustor, the method comprising:
(a) providing a flame inhibitor adjacent and upstream of each of said plural, radially-oriented fuel pegs;
(b) aligning said flame inhibitor relative to fuel delivery holes in each of said plural, radially-oriented fuel pegs, such that vortices are created in said combustion air sufficient to insure premixing of the fuel issued from said fuel delivery holes, and to prevent fuel from adhering to exterior surfaces of each of said plural, radially-oriented fuel pegs.

19. The method of claim 18 wherein step (a) includes providing a flame inhibitor having a base portion and an upstanding support extending away from said base portion, the flame inhibitor comprising a pair of substantially vertically-aligned delta-wing-shaped flaps on said upstanding support, each having a relatively pointed end and a relatively broad end and arranged such that said delta-wing-shaped flaps extend at acute opposite angles relative to each other.

20. The method of claim 19 including forming said base portion, said upstanding support and said pair of substantially vertically-aligned delta-wing-shaped flaps from a single piece of metal stock.
